(19) United States
(12) Patent Application Publication
(10) Pub. No.: US 2010/0031282 A1
(43) Pub. Date: Feb. 4, 2010

(54) Display device, remote operation device and computer-readable medium storing display program

(75) Inventor: Hiroshi TORIMARU, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/457,050

(22) Filed: May 29, 2009

(30) Foreign Application Priority Data
Aug. 1, 2008 (JP) 2008-199222

(51) Int. Cl. H04H 60/33; H04N 5/445; H04N 5/44

(52) U.S. Cl. 725/9; 725/46; 348/734; 348/E05.096

(57) ABSTRACT

The display device includes a priority calculation unit which calculates the priority so that the priority of category to which a program viewed by the user belongs is increased and the priority of the other category is decreased, a program feature information storage unit which stores correspondence information between the category and a feature word, a program feature extraction unit which extracts the feature word for each program from program information, a display program control unit which selects the program belonging to the category in which the priority is the highest from the programs being broadcast, and a program display processing unit which displays the selected program.

### CROSS-REFERENCE TO RELATED APPLICATIONS

This application is based upon and claims the benefit of priority of the prior Japanese Patent Application No. 2008-199222, filed on Aug. 1, 2008, the entire contents of which are incorporated herein by reference.

### FIELD

The embodiments discussed herein is related to a display device having a function of displaying the broadcast programs for which a viewer (hereinafter referred to as “user”) of the programs to be broadcast has preference, using information on the broadcast program, a remote operation device that sends an instruction signal to the display device, and a computer-readable medium storing display program to be executed on a computer.

### BACKGROUND

In a display device such as a television that displays broadcast programs, a broadcasting station is assigned to each channel. Therefore, the user needs to search a channel or broadcasting date and time for broadcasting a program that the user wants to view and select the channel.

In recent years, the television having a function of receiving broadcasting program information such as an EPG (Electronic Program Guide) has spread. The EPG is information on the broadcasting program that are distributed via the airwaves or the Internet and includes information for each program on the broadcasting date, broadcasting start/end time, broadcasting station, program name (band/individual), performer, and the outline of contents, and the genre (category) set on the program distribution side such as sports, drama and media report. The television having the EPG receiving function can display a program guide based on a predetermined genre, in addition to a program guide for each channel, using the EPG, whereby the user can select the program desired to view with the genre as a clue.

However, in either case, the user must search a broadcasting schedule of the program desired to view then select the applicable channel. In the general television, the channel that has been displayed when the power is turned off previously is automatically displayed when the television is turned on next. Therefore, the channel that the user wants to view is not always displayed, thereby the user has to do a channel switching operation.

A technique for the television is well known in which the channel considered for the user to select most frequently can be set as a “favorite channel” to a remote controller gadget for channel tuning. Thus, the set “favorite channel” is automatically selected to display the program when the power is turned on.

Also, a technique for accumulating program summary in a database is well known in which the priority based on the liking of the viewer is calculated for each program summary, and the summary in the database is discarded or replaced, based on the priority. Also, a technique is well known in which if the capacity of database for accumulating the program summary is insufficient; the summary having lower priority is discarded to accumulate a newly received program summary.

Also, a technique is well known in which a score for each program or each genre of program is computed so that the program viewed at the newer date by the user has the higher score, each program or genre is ordered based on the score, and the program explanation contents of the program belonging to the program or genre of a predetermined order or higher are acquired.

The following are references which are studied by the inventor and are describe the technological backgrounds of the discussed embodiment:

Patent Document 1: Japanese Patent Laid-Open No. 10-336535,

Patent Document 2: Japanese Patent Laid-Open No. 3418540,

Patent Document 3: Japanese Patent Laid-Open No. 11-196385, and

Patent Document 4: Japanese Patent Laid-Open No. 2001-16522.

In recent years, a multi-channel program distribution method with CS (communication satellite) or broadcasting satellite or cable has spread. Accordingly, there is scarcely a situation where the channel that the user wants to view is set to the preset “favorite channel” as described above.

In such the situation, it is still required for the user to be ready to grasp a channel, including the “favorite channel”, on which the program that the user wants to view is broadcasted. Further, if the program which the user desires to view is broadcasted on a different channel not the “favorite channel”, it is not possible to relieve the user the trouble of searching the channel for the program and tuning in to the program. A program guide of the EPG serves as an aid to search for the program, but a channel tuning operation itself can not be omitted.

In the multi-channel distribution system with the CS, cable or the like that has recently spread, it is getting troublesome to search on which channel the program desired to view is broadcast. For example, since the same program may be broadcasted in different hours set by each distribution company, the program guide becomes complex. Further, since the same program may be placed into different genres by each distribution company, it is difficult to look for a desired program by genres. Accordingly, there is a demand for a mechanism for allowing the user to certainly view a program which he/she desires to view without knowing beforehand the broadcasting date and time.

Also, there is conceivably a case where the program of the genre (category) that the user usually hardly views may happen to include the contents which the user is considered to rather prefer. For example, when the program is mainly and preferentially displayed simply based on the genre (category) selected with the user's preference, the user may miss the program which includes the contents the user prefers.

Also, the preference of the user may change with the time. For example, with a way for adding scores to each genre simply based on the viewing history of the user, it may be difficult to adjust change in the preference of the user.

### SUMMARY

The discussed display device which has a function of displaying a broadcast program in accordance with preference of a user, the display device includes a priority information storage unit for storing a priority for each category into which the program is classified; a priority calculation unit for, when a program is viewed, calculating a priority of the category in order to increase the priority of the category to which the viewed broadcast program belongs; a program feature information storage unit for storing correspondence information indicating a correspondence relation between the category and a feature word representing feature of the program classified into the category; a program information collection unit for acquiring program information of the broadcast program at a predetermined opportunity; a program feature extraction unit for extracting a feature word representing feature of the broadcast program from the acquired program information for each program; a display program control unit for specifying the category, the priority of which is the highest, and selecting one or more programs belonging to the specified category among programs currently broadcasted; and a program display processing unit for displaying the selected one or more programs, and wherein, when the program feature extraction unit extracts the feature word associated with a certain category from the program belonging to another different category than the associated category, the priority calculation unit temporarily changes the priority of the category to which the broadcast program, from which the feature word is extracted, belongs by using the priority of the category with which the feature word is associated.

In the above display device, the category may include a first category into which the programs are classified according to a superordinate concept, and a second category into which the first category is further finely classified, and the program feature extraction unit may specify the second category with which the feature word is associated based on the feature word extracted from the program information and the correspondence information for each program, and when the specified second category does not belong to the first category of the program from which the feature word is extracted, the priority calculation unit may temporarily change the priority of the second category or the priority of the first category from which the feature word is extracted by using the priority of the specified second category or the first category superior to the specified second category.

The remote operation device for operating this display device with an instruction signal can be provided with a function of displaying the program to the preference of the user in the display device.

The above process can be realized by the display device or remote operation device including a CPU and memory and a software program read and executed by the CPU within the device. The program can be stored in a suitable recording medium such as a portable medium memory or semiconductor memory readable by the CPU, and provided by being recorded on these recording media or distributed via a communication interface using various communication networks.

A program considered to suit to the preference of the user is preferentially displayed on the display device in the basis of the program history viewed by the user. Therefore, the user can know the program on the air in the field where the user wants to view the program without knowing beforehand the program guide information. Accordingly, when the power of the display device is turned on, the user is relieved from the trouble of checking the program guide and selecting the channel and can view the favorite program without missing it.

Also, if the program of the genre (category) in which the user does not usually view for pleasure includes the contents to the preference of the user, the program is preferentially displayed on the display device, whereby the user can view the program that happens to include the contents to the liking without missing it.

Also, a program considered to the preference of the user is preferentially displayed on the display device by flexibly coping with a change in the preference of the user. Therefore, the user can view the program to which he/she may prefer at the time without missing it.

Hence, the usability of the display device for displaying a broadcasting program is remarkably improved.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration example of a display device and a remote operation device according to this embodiment;

FIG. 2 is a view illustrating a data organization example of EPG information according to this embodiment;

FIG. 3 is a view illustrating a data organization example of priority information according to this embodiment;

FIG. 4 is a view illustrating a data organization example of program feature information according to this embodiment;

FIG. 5 is a view for explaining the selection of a program based on the program priority according to this embodiment;

FIG. 6 is a view illustrating an example (1) of thumbnail picture display according to this embodiment;

FIG. 7 is a view illustrating an example (2) of thumbnail picture display according to this embodiment;

FIG. 8 is a view illustrating an example (3) of thumbnail picture display according to this embodiment;

FIG. 9 is a view illustrating an example (4) of thumbnail picture display according to this embodiment;

FIG. 10 is a view illustrating an image of how the priority of category/subcategory changes with viewing by the user;

FIG. 11 is a view for explaining an example of addition/subtraction of priority according to this embodiment;

FIG. 12 is a priority update processing flowchart according to this embodiment;

FIG. 13 is a view illustrating an image of how the priority of category/subcategory changes when the contents to suit a fondness of the user are included in the program of category that the user does not usually view;

FIG. 14 is a priority temporary update processing flowchart according to this embodiment;

FIG. 15 is a flowchart illustrating the outline of the processing flow of a television according to this embodiment;

FIG. 16 is a flowchart illustrating the flow of a program presentation process when the power of the television is turned on according to this embodiment;

FIG. 17 is a flowchart illustrating the flow of the program presentation process while the viewer is viewing the program according to this embodiment;

FIG. 18 is a flowchart illustrating the flow of the program presentation process when the program displayed in normal picture is ended according to this embodiment;

FIG. 19 is a diagram illustrating a configuration example where the remote controller is provided with a program presentation function and a priority update function according to this embodiment; and

FIG. 20 is a view illustrating an example of an instruction input unit and an indicator in the remote controller according to this embodiment.

### DESCRIPTION OF EMBODIMENT

A preferred embodiments of the present invention will be explained with reference to accompanying drawings.

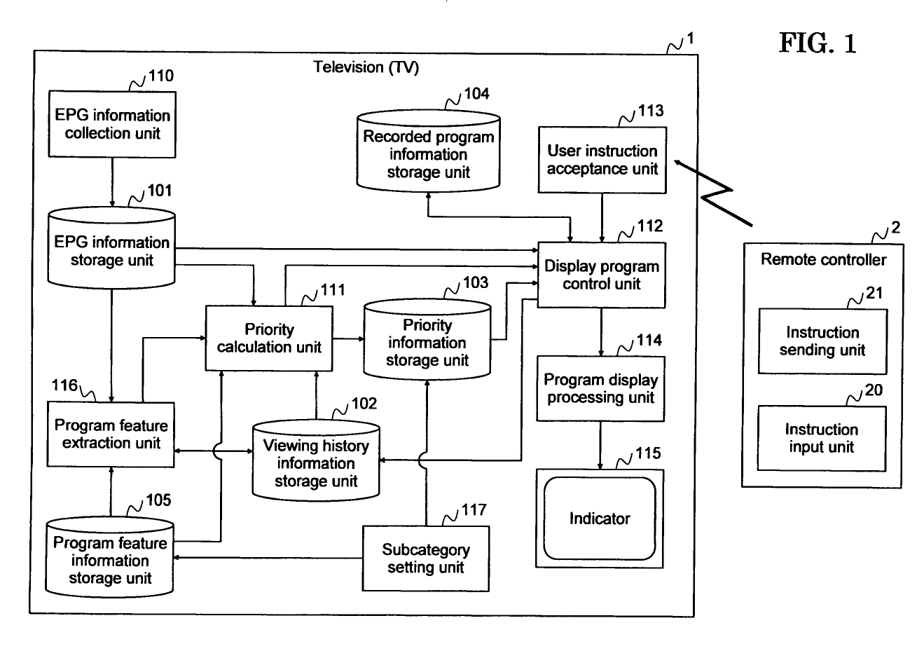

FIG. 1 is a view illustrating a configuration example of a display device and a remote operation device according to this embodiment. In FIG. 1, a television set having a favorite program display function 1 (hereinafter referred to as a television 1) is a display device for television program or recorded program. Also, a remote controller 2 is a remote operation device that sends an instruction signal to the television 1.

The television 1 includes an EPG information storage unit 101, a viewing history information storage unit 102, a priority information storage unit 103, a recorded program information storage unit 104, a program feature information storage unit 105, an EPG information collection unit 110, a priority calculation unit 111, a display program control unit 112, a user instruction acceptance unit 113, a program display processing unit 114, an indicator 115, a program feature extraction unit 116, and a subcategory setting unit 117.

The EPG information storage unit 101 is means for storing the program information representing the contents of a program to be broadcast. Herein, the EPG information distributed through the airwaves or the Internet is stored as program information.

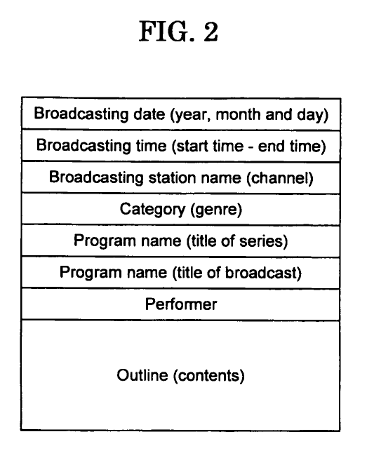

FIG. 2 is a view illustrating a data organization example of the EPG information according to this embodiment. The EPG information includes broadcasting date, broadcasting time, broadcasting station name (channel), category (genre), program name, performer, and outline (summary of contents), for each program, as illustrated in FIG. 2. The category is a classification based on the program contents classified and given by the program distributor, and may be “sports”, “drama”, “variety”, “movie” or “news”, for example.

The viewing history information storage unit 102 is a unit for storing the viewing history information of the program viewed by the user. The viewing history information is generated from the EPG information of the program viewed by the user. Further, the viewing history information is given a subcategory into which the category is more finely classified.

The priority information storage unit 103 is a unit for storing the priority information of each category or each subcategory. The category or subcategory means a unit in which the priority is given. The category is set in the EPG information by the program distributor. The subcategory is a more detailed classification of the category, and set by the user.

The category in this embodiment represents a first category into which the programs are classified according to a superordinate concept, and the subcategory in this embodiment represents a second category into which the first category is more finely classified. By setting the subcategory, the program can be displayed using the more detailed classification to suit the preference of the user than the category set by the program distributor.

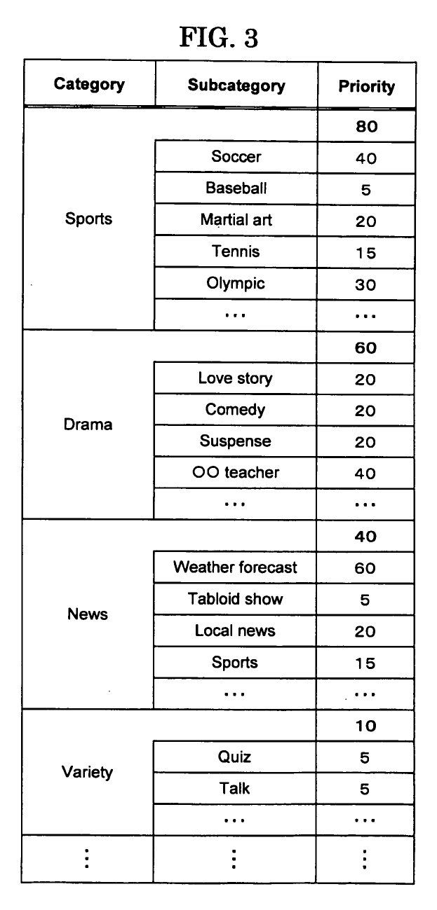

FIG. 3 is a view illustrating a data organization example of the priority information according to this embodiment. In the priority information, the priority is recorded for each category or each subcategory, as illustrated in FIG. 3.

In FIG. 3, the category of priority information is a category set in the EPG information, and may be, for example, “sports”, “drama”, “news”, “variety” and the like. Also, the subcategory of priority information is the subcategory set by the user, and may be, for example, “soccer”, “baseball”, “martial art”, “tennis”, “Olympic” and the like in the category of “sports”.

The recorded program information storage unit 104 is a unit for storing the index information of the program recorded by a program recording playback apparatus (not shown) linked to the television 1.

The program feature information storage unit 105 is a unit for storing the correspondence information indicating a correspondence relationship between a subcategory and a feature word included in the program classified into the subcategory. The feature word of correspondence information is a word appearing in the EPG information as the word representing the feature of program contents, and may be a noun or an adjective word included in the program name (title of program series, title of each broadcast), performer of the program or the outline (the summary of the contents), for example.

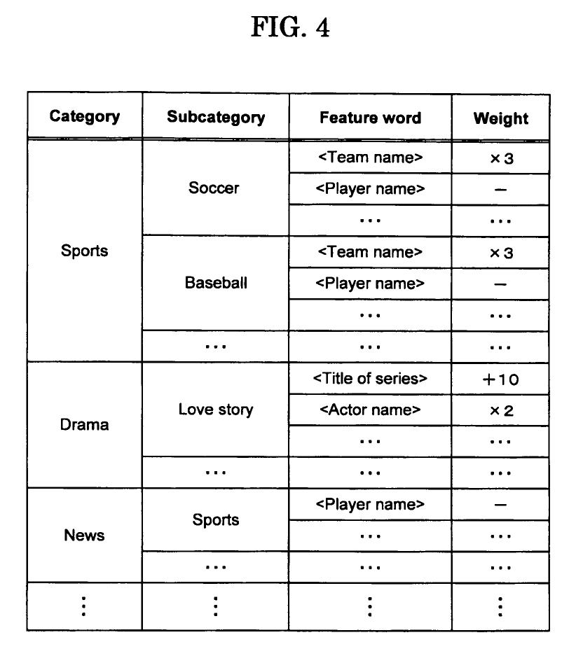

FIG. 4 is a view illustrating a data organization example of the program feature information according to this embodiment. The feature word is associated with the program feature information for each category or each subcategory, and stored. In the example of the program feature information as illustrated in FIG. 4, the feature word is stored for each subcategory. In FIG. 4, a <team name> in the column of the feature word means that a specific team name is registered as the feature word by the user.

Also, a weight for priority calculation may be stored for each feature word or each group of feature words. In the example of the program feature information as illustrated in FIG. 4, the weight is stored for each feature word.

The EPG information collection unit 110 is a unit for collecting the EPG information distributed through the airwaves or the Internet or the like and storing it in the EPG information storage unit 101.

The priority calculation unit 111 is a unit for computing the appearance number (past viewing number) that the program viewed in the past appears in the viewing history information for each category, calculating the priority of each category based on the appearance number and storing it in the priority information storage unit 103.

Also, the priority calculation unit 111 computes the appearance number (past viewing number) for each subcategory, calculates the priority of each subcategory based on the appearance number and stores it in the priority information storage unit 103, if the subcategory is given to the viewing history information.

Also, the priority calculation unit 111 calculates the program priority from the total appearance number of feature word included in the program information of the program currently on the air by referring to the appearance number of each feature word in the viewing history information obtained by the program feature extraction unit 116, as will be described later.

Further, the priority calculation unit 111 may calculate the program priority by weighting the appearance number of applicable feature word after storing the feature word or the group of feature words to be weighted for each category or each subcategory.

For example, the program belonging to the category “sports”, or the program belonging to the subcategory “soccer” in the category “sports” is weighted by “trebling (×3) the appearance number”, if the feature word extracted from the EPG information is the specific <team name>, as illustrated in FIG. 4. Also, the program belonging to the category “drama” is weighted by “adding 10 (+10) to the appearance number”, if the feature word extracted from the EPG information is the <series title> of the specific program, or weighted by “doubling (×2) the appearance number”, if the feature word is the specific <actor name>.

The priority calculation unit 111 is a unit for computing the appearance number (past viewing number) for each category in the viewing history information of the program viewed in the past, calculating the priority of each category based on the appearance number and storing it in the priority information storage unit 103.

Also, the priority calculation unit 111 calculates the priority so that the priority of the category or subcategory to which the program viewed by the user belongs is increased or the priority of any other category or subcategory than the category or subcategory to which the program viewed by the user belongs is decreased.

Also, the priority calculation unit 111 decides a value of priority so that the calculated priority may fall within a predetermined range, if the calculated priority is outside the predetermined range (the priority is higher than a predetermined upper value or lower than a predetermined lower value).

Also, the priority calculation unit 111 changes the priority of the category or subcategory to which the program belongs to the priority decided based on the priority of category or subcategory with which the extracted feature word is associated for only a predetermined period, if the feature word associated with the certain category or subcategory is extracted from the program belonging to the other category or subcategory.

The display program control unit 112 is a unit for acquiring the EPG information of the program currently on the air from the EPG information storage unit 101, and selecting one or more programs belonging to the category or subcategory in which the priority stored in the priority information storage unit 103 is the highest, when the power of the television 1 is turned on or at every predetermined opportunity. Also, the display program control unit 112 generates the viewing history information from the program information of the viewed program and stores it in the viewing history information storage unit 102.

The user instruction acceptance unit 113 is a unit for receiving an instruction signal containing a user instruction sent from the remote controller 2.

The program display processing unit 114 is a unit for displaying each of one or more programs selected by the display program control unit 112 in thumbnail picture of the size according to the priority of the program on the indicator 115, and displaying the program instructed to view in normal picture on the indicator 115, upon accepting a viewing instruction of the user. The program display processing unit 114 displays the program in thumbnail picture of the larger size in order of priority in the sequence decided by the display program control unit 112.

The program feature extraction unit 116 extracts the feature word from the viewing history information for each program viewed in the past, and specifies the subcategory with which the extracted feature word is best matched by referring to the correspondence information between the subcategory and the feature word (i.e., program feature information stored in the program feature information storage unit 105). The specified subcategory is appended to the viewing history information of the applicable program in the viewing history information storage unit 102.

Also, the program feature extraction unit 116 extracts the feature word from the EPG information for each program currently on the air, specifies the subcategory with which the extracted feature word is best matched by referring to the correspondence information, and notifies the specified subcategory to the priority calculation unit 111.

Also, the program feature extraction unit 116 extracts the feature words from all the viewing history information, and calculates the appearance number of each extracted feature word in the viewing history information. Also, the program feature extraction unit extracts the feature word from the EPG information for each program currently on the air. And the program feature extraction unit notifies the appearance number of each feature word and the feature word of each program currently on the air to the priority calculation unit 111.

Also, the program feature extraction unit 116 extracts the feature word for each program from the EPG information, and notifies the program from which the feature word is extracted and the extracted feature word to the priority calculation unit 111, when the feature word associated with the certain category or subcategory is extracted from the program belonging to another category or subcategory.

The subcategory setting unit 117 is a unit for editing the subcategory, correspondence information of the feature word and weight by an input operation of the user.

The remoter controller 2 includes an instruction input unit 20 and an instruction sending unit 21.

The instruction input unit 20 is a unit for accepting a viewing object indicating the program desired to view or an instruction input for switching the category display by an input operation of the user.

The instruction sending unit 21 is a unit for sending an instruction signal containing an inputted user instruction to the television 1.

A method for selecting the program displayed in thumbnail picture will be described below.

The display program control unit 112 decides the group of programs displayed in thumbnail picture on a category or subcategory basis. When plural programs belonging to the decided category or subcategory are broadcast, the program within a predetermined number of display thumbnail pictures or exceeding a predetermined threshold of priority is selected in the following manner.

If the group of programs displayed in thumbnail picture is decided according to the priority of category, the program is selected using the priority of subcategory making up the applicable category. That is, the programs are selected successively from among the programs belonging to the subcategory in order of priority, based on the priority of subcategory making up the applicable category. Or the programs are selected in order of program priority from among the programs belonging to the applicable category, using the program priority of the program belonging to the applicable category.

Also, if the group of programs displayed in thumbnail picture is decided according to the priority of subcategory, the programs are selected in order of program priority from among the programs belonging to the applicable subcategory, using the program priority of the program belonging to the applicable subcategory.

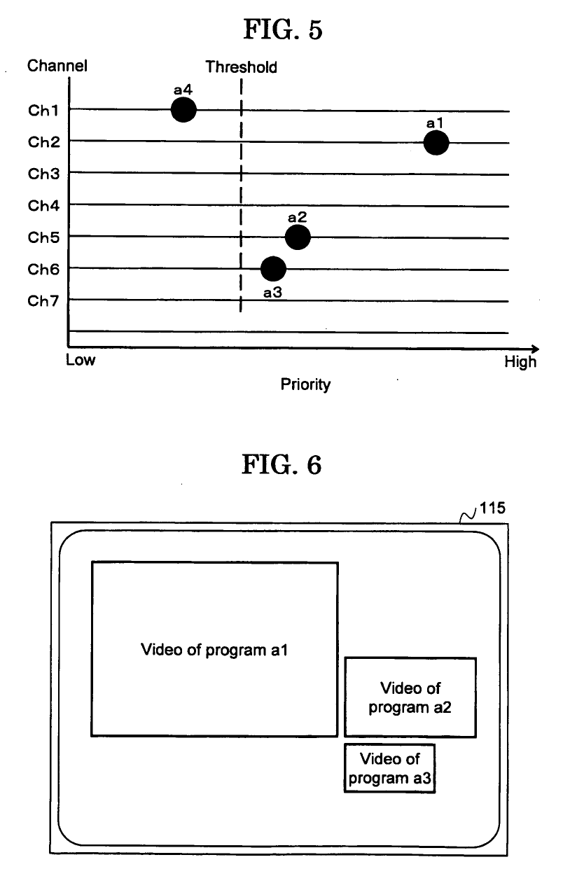

FIG. 5 is a view for explaining the selection of a program based on the program priority according to this embodiment. It is assumed that as the group of programs displayed in thumbnail picture, four programs a1 to a4 belonging to the category “A”, for example, are selected. These programs a1 to a4 have the program priority as illustrated in FIG. 5, in which the programs a1 to a3 have the program priority exceeding the threshold of priority.

The display program control unit 112 selects the programs a1 to a3 from among the programs a1 to a4 of the category “A” having the maximum priority, and notifies the order of programs a1, a2 and a3 (order of program priority) to the program display processing unit 114.

FIG. 6 is a view illustrating an example (1) of thumbnail picture display according to this embodiment. The program display processing unit 114 displays the programs in thumbnail picture of the smaller size in order of program priority, namely, in order of programs a1, a2 and a3 on the indicator 115, as shown in FIG. 6.

Further, the display program control unit 112 specifies the category/subcategory having the highest priority next to the category/subcategory on display by referring to the priority information storage unit 103, if a switching instruction of the category of the program displayed in thumbnail picture on the indicator 115 is accepted in the user instruction acceptance unit 113. And one or more programs belonging to the specified category/subcategory are selected in the above manner. For example, it is supposed that the order of programs b1 and b2 belonging to the category “B” having the highest priority next to the category “A” is notified.

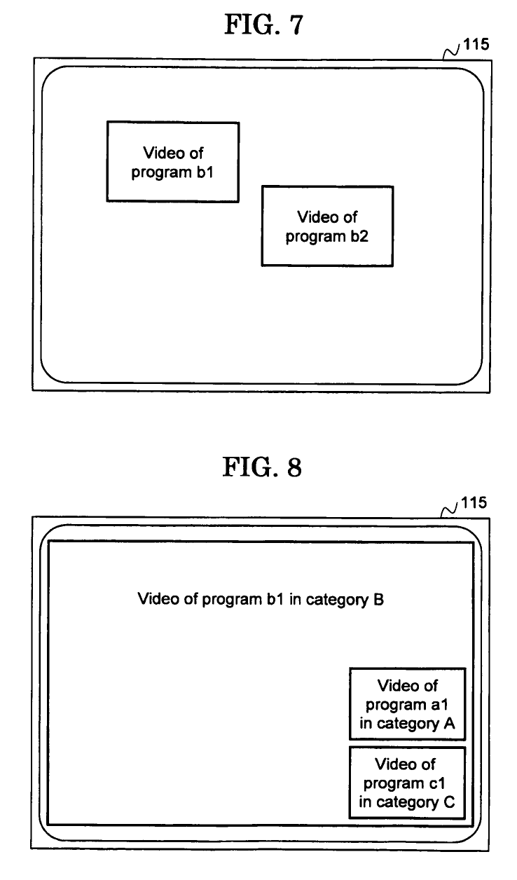

FIG. 7 is a view illustrating an example (2) of thumbnail picture display according to this embodiment. The program display processing unit 114 displays the programs b1 and b2 belonging to the category “B” in thumbnail picture, as illustrated in FIG. 7.

Further, the display program control unit 112 selects one of the non-display category/subcategory programs when there is the program belonging to the category/subcategory (non-display category/subcategory) other than the category/subcategory of the program that starts to be broadcast at this point of time and displayed by referring to the EPG information of the EPG information storage unit 101, if the program is displayed in normal picture on the indicator 115.

FIG. 8 is a view illustrating an example (3) of thumbnail picture display according to this embodiment. For example, if the program b1 of category “B” is displayed in normal picture, the program display processing unit 114 displays the program a1 of another category “A” and the program c1 of category “C” in thumbnail picture respectively, as illustrated in FIG. 8.

Further, the display program control unit 112 designates one of plural programs, which is not designated as the viewing object by the user, as the recording object, and notifies a recording instruction to the program recording playback apparatus (not illustrated in FIG. 1) linked to the television 1, when the program priority of plural programs displayed in thumbnail picture on the indicator 115 is greater than or equal to a predetermined value, and within a predetermined range. At this time, the index information of the program of the recording object is stored in the recorded program information storage unit 104.

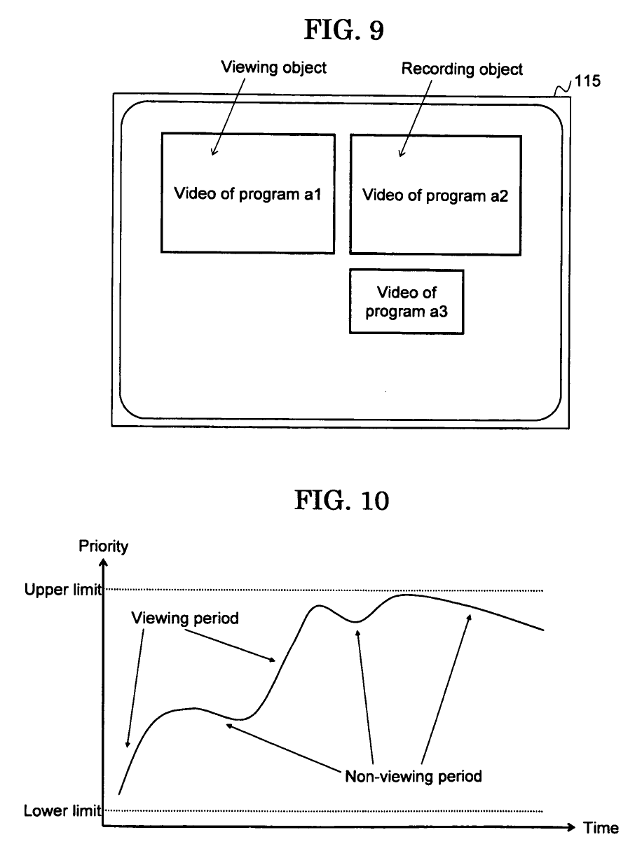

FIG. 9 is a view illustrating an example (4) of thumbnail picture display according to this embodiment. If the programs a1 and a2 of the category “A” have the almost same program priority, the program display processing unit 114 displays the programs a1 and a2 of the category “A” in thumbnail picture of the almost same size on the indicator 115, as illustrated in FIG. 9. Herein, if the user selects the program a1 as the viewing object, the display program control unit 112 specifies the unselected program a2 as the recording object, and stores the index information for specifying the recording information of the program a2 in the recorded program information storage unit 104. Also, the program display processing unit 114 displays the program a1 in normal picture on the indicator 115 by changing thumbnail picture to normal picture.

Next, a process of the invention will be described below using a specific example.

Herein, it is supposed that the priority information storage unit 103 stores the priority of category/subcategory, as shown in FIG. 3.

When the power of the television 1 is turned on, the display program control unit 112 selects the program with the category “sports” currently on the air from the EPG information by referring to the priority information storage unit 103, because the priority of the category “sports” is the highest.

Herein, it is assumed that there are three programs belonging to the category “sports”. The feature word is extracted from each of the EPG information of these three programs belonging to the category “sports”, and specifies the subcategory as “soccer”, “baseball” or “swimming (subcategory unregistered)” respectively by referring to the correspondence information. The program of “swimming” is internally treated as the program with the category “sports” that is not classified into the specific subcategory, because the subcategory is not particularly set.

For example, assuming that the number of thumbnail pictures displayed concurrently on the screen of the indicator 115 is set to four, the programs of “soccer”, “baseball” and “swimming” are selected as the programs for thumbnail picture display, because the number of programs extracted from the EPG information is equal to or less than the number of thumbnail pictures.

The program display processing unit 114 displays the program of “soccer” in thumbnail picture of large size, the program of “baseball” in thumbnail picture of medium size and the program of “swimming” in thumbnail picture of small size on the indicator 115, because the priority of the subcategory “soccer”, “baseball” or “swimming” of each selected program is 40, 5 or 0 (=unregistered). The “swimming” is the program not classified into the specific subcategory, and has the priority of 0.

Assuming that the user selects the program of “soccer” as the viewing object, the program display processing unit 114 ends displaying two programs of “baseball” and “swimming” in thumbnail picture, and displays the program of “soccer” in normal picture. Also, the EPG information of the program of “soccer” selected to view is stored as the viewing history information in the viewing history information storage unit 102.

Assuming that the recording process threshold for the non-display program is set to “within 20”, the display program control unit 112 does not set the program of “baseball” as the recording object“, because a difference between the priority (40) of the program of “soccer” and the priority (5) of the program of “baseball” is “35”, and exceeds the set threshold.

If the user selects the program of “baseball”, not the program of “soccer”, as the viewing object, the program display processing unit ends displaying two programs of “soccer” and “swimming” in thumbnail picture and displays the program of “baseball” in normal picture. The display program control unit 112 sets the program of “soccer” having the higher priority than “baseball” as the recording object, notifies it to the program recording playback apparatus, and stores the index information of the program of “soccer” in the recorded program information storage unit 104.

In this manner, the television 1 displays the programs on the air belonging to the category/subcategory, which the user used to often view, in a list form, when the power is turned on. The user can select the program desired to view without checking a program schedule. Also, even in the case where the user selects the program of the category/subcategory that is not too often viewed in the past as the viewing object, the program of the category/subcategory that is more often viewed is automatically recorded and stored while the program is on the air, whereby it is possible to avoid a situation where the program desired to view is missed.

Further, the priority calculation unit 111 of the television 1 updates the priority of the category and subcategory, because the information of the viewing history information storage unit 102 is updated. Herein, in the case where the viewing number (appearance number) is directly used as the priority. For example, when the program of “soccer” is selected as the viewing object, one point is added (+1) to the category “sports” and the subcategory “soccer”, whereby the priority of category and subcategory is updated.

Also, in the case where the priority of subcategory is updated by adding the viewing number (appearance number) to only the subcategory “soccer”, and a total of 10 points is added (+10) to one or more subcategories belonging to the same category “sports”, the priority of category may be updated by adding one point (+1) to the category “sports”.

The calculation of priority as described above is a way for adding the priority of category/subcategory to which the program viewed by the user belongs. However, a priority calculation method as described above was a way in which because the upper limit of the priority is not set up, the priority of the category/subcategory particularly often viewed is extremely high, and even if the program of the category/subcategory is not thereafter viewed, the priority does not fall.

To cope with this situation, it is possible to incorporate a way for decreasing the priority, such as decreasing the priority of category/subcategory not viewed beyond a certain period, or decreasing the priority of category/subcategory other than the category/subcategory to which the program selected for viewing by the user belongs, for example. Thereby, in the case where the category/subcategory viewed for pleasure at a certain time is thereafter hardly viewed, the priority is not kept high indefinitely, making it possible to present the program to the preference of the user at that time.

Also, the upper limit value of priority may be set to control the value of the priority of the specific category/subcategory not to increase extremely high. Also, the lower limit value of priority may be set to control the value of the priority of the specific category/subcategory not to decrease extremely low. Thereby, it does not occur that the priority of the specific category/subcategory becomes extremely high or low, whereby it is possible to flexibly cope with a change in the preference of the user.

FIG. 10 is a view illustrating an image of how the priority of category/subcategory changes with viewing by the user.

In a certain category/subcategory, the priority of the category/subcategory is added at the time when the user views the category/subcategory, as illustrated in FIG. 10. At the time when the user does not view the category/subcategory, the priority of the category/subcategory is subtracted.

Also, the priority is set to the upper limit value and the lower limit value, whereby the priority is controlled not to exceed the set upper limit value and not to fall below the set lower limit value.

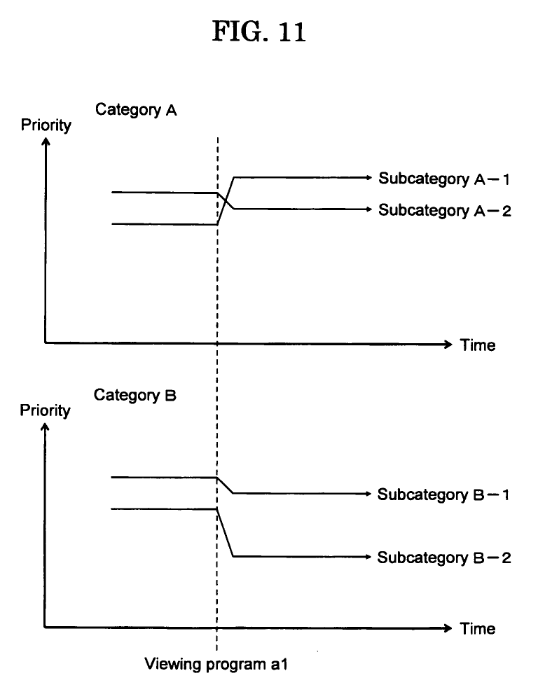

FIG. 11 is a view for explaining an example of addition/subtraction of priority according to this embodiment. In the example as described herein, the priority of the category/subcategory to which the program viewed by the user belongs is increased, and the priority of any other category/subcategory is decreased.

The user views the program a1 belonging to the subcategory A-1 of the category A. At this time, the priority calculation unit 111 increases the priority of the subcategory A-1 to which the program a1 belongs, based on viewing of the program a1, as illustrated in FIG. 11. The priority of the category A to which the subcategory A-1 belongs is also increased, though not illustrated here.

Also, the priority calculation unit 111 decreases the priority of any other subcategory than the subcategory A-1 to which the program a1 belongs. The priority of the subcategory A-2 belonging to the same category A as the subcategory A-1 is decreased, as illustrated in FIG. 11. The priority of the subcategory B-1 and subcategory B-2 belonging to the category B is also decreased. The priority of the category B is also decreased, though not illustrated here.

Various calculation methods for addition or subtraction of the priority may be considered.

For the addition of the priority, the rank of the priority may be updated to linearly increase with the user's viewing number as in the above example, or may be updated by calculating the increase amount of priority using various functions such as a quadratic function with the user's viewing number, for example. Also, the number of points may be added to the priority of the category/subcategory to which the program belongs at the time when the user selects the program for viewing, or the priority is increased based on a plurality of viewing histories in the past including the viewing history of the program. A setting unit (not illustrated) for setting a rise (an increase) in the priority for calculation by a choice of the user may be provided to allow the user to select how to increase the priority.

Also, for the subtraction of the priority, for example, the priority may be updated to decrease when the user views the program of another category/subcategory as in the above example, or the priority may be updated to decrease if the program is not viewed for a certain period or by a certain number of times. Also, a degree of decrease in the priority (linearly decreasing, or decreasing like a quadratic function) may be optionally designed in the same manner as the rise in the priority. A setting unit (not illustrated) for setting a decrease in the priority for calculation by a choice of the user may be provided to allow the user to select how to decrease the priority.

For example, it is assumed that the subcategory B-2 is not viewed for a longer time than the subcategory B-1 in the category B illustrated in FIG. 11. In such a case, the subcategory B-2 that is not viewed for the longer time than the subcategory B-1 may be designed so that the priority may decrease more greatly, as illustrated in FIG. 11.

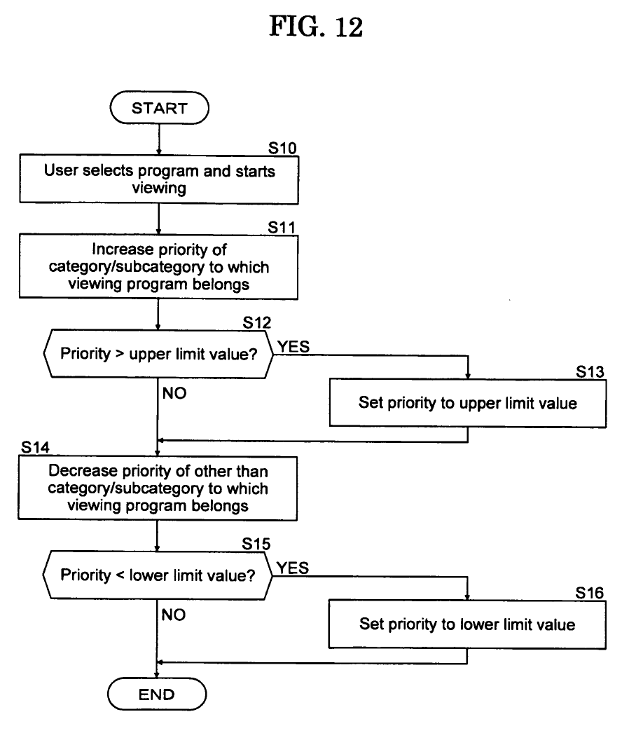

FIG. 12 is a priority update processing flowchart according to this embodiment.

If the user selects the program and starts to view the selected program (step S10), the priority calculation unit 111 increases the priority of the category/subcategory to which the viewing program of the user belongs in accordance with a predetermined calculation method, based on the program viewing of the user (step S11). If the increased priority exceeds a predetermined upper limit value (YES at step S12), the value of the priority is set to the predetermined upper limit value (step S13).

Also, the priority of the category/subcategory other than the category/subcategory to which the viewing program of the user belongs is decreased in accordance with the predetermined calculation method (step S14). If the decreased priority falls below a predetermined lower limit value (YES at step S15), the value of the priority is set to the predetermined lower limit value (step S16).

Next, it is assumed that when the user views the program of “romantic drama” displayed in normal picture, the broadcasting of three programs of “weather forecast, tennis and suspense drama” is started at the almost same time. Also, it is assumed that the number of thumbnail pictures displayed on the screen of the indicator 115 at the same time is set to two.

In this manner, if the program of comparison object of the priority extends over a plurality of categories, the display program control unit 112 performs the process in the following manner.

First of all, the display program control unit 112 specifies the subcategory of the started program through the above process. And the weather forecast (category=news, priority=60), tennis (sports, 15) and suspense drama (drama, 20) are acquired from the priority information as shown in FIG. 3, and the priority of category of each program is decided, using the priority of category and subcategory to which each program belongs.

Herein, the priority is obtained by “priority of category x priority of subcategory”, that is by multiplying the priority of category by the priority of subcategory. Accordingly, the priority of category of “weather forecast” is “2400” (priority (40) of category “news”×priority (60) of subcategory “weather forecast”). Similarly, the priority of “tennis” is “1200” (priority (80) of category “sports”×priority (15) of subcategory “tennis”), and the priority of “suspense drama” is “1200” (priority (60) of category “drama”×priority (20) of subcategory “suspense”).

Also, the priority of the program of “romantic drama” displayed in normal picture at present is obtained in the same manner. Herein, the priority is “1200” (priority (60) of category “drama”×priority (20) of subcategory “love story”).

The display program control unit 112 selects the program of “weather forecast” having the higher priority and the program (program of “tennis”) having the higher priority of category of two programs (program of “tennis” and program of “suspense drama”) having the same priority as the programs displayed in thumbnail picture.

The program display processing unit 114 displays the programs of “weather forecast” and “tennis” in thumbnail pictures (corresponding to the programs a1 and c1 in FIG. 8), when the user views the program of “romantic drama” (corresponding to the program b1 in FIG. 8) displayed in normal picture, as shown in FIG. 8, for example.

If the user selects the program of “weather forecast” as the viewing object by watching the thumbnail pictures, the program display processing unit 114 displays the program of “weather forecast” in normal picture, and erases the thumbnail picture of “tennis”. Also, the display program control unit 112 specifies the program “romantic drama” displayed in normal picture up to this time as the recording object, and notifies a recording instruction to the program recording playback apparatus.

In the case where the user still views the “romantic drama” without changing the program within a certain period, the program display processing unit erases the thumbnail pictures, specifies the program of “weather forecast” as the recording object, because the priority of the program of “weather forecast” displayed in thumbnail picture is higher than the priority of the program of “romantic drama” during viewing, and notifies a recording instruction to the program recording playback apparatus.

If the priority of the program displayed in thumbnail picture is lower than the priority of the program being viewed by the user, namely, the program being displayed in normal picture, and below a predetermined threshold, the program displayed in thumbnail picture is not made the recording object.

In this manner, the user can know the start of the program of the category often viewed even during viewing of another program, and the program having the high priority can be automatically recorded and stored in the program recording playback apparatus linked to the television 1, whereby it is possible to avoid a situation where the program desired to view is missed.

Next, an exceptional process for the priority where the program of the category that the user does not usually view includes the favorite contents of the user will be described below.

For example, it is supposed that the user usually views the soccer game or news of the result often, but hardly views the variety program. Herein, it is supposed that a special edition in which the world cup participating members appear is prepared in the variety program. In the specifications as described so far, the variety program in which the special edition in which the world cup participating members appear is prepared is less likely to be subject to the thumbnail display, because the priority of the category “variety” is low, whereby there is the possibility that the user misses the program.

To cope with such a situation, if there is the program pertinent to the preference of the user even with the category having the low priority that the user usually does not view, a way for temporarily increasing the priority of the category is provided.

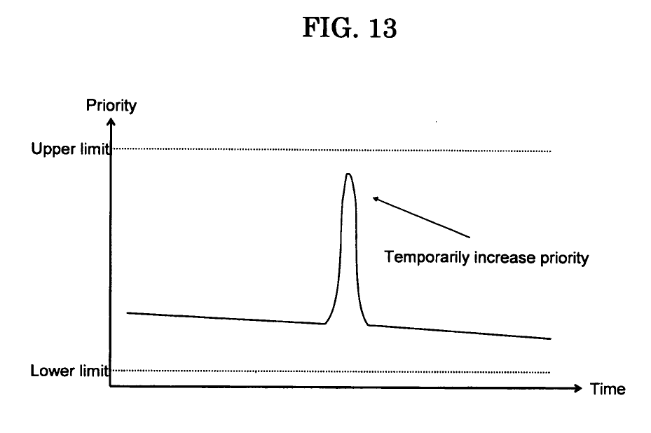

FIG. 13 is a view illustrating an image of how the priority of category/subcategory changes when the user's favorite contents are included in the program of category that the user does not usually view.

The priority of category/subcategory that the user does not usually view is normally in a low state, as illustrated in FIG. 13. If there is the program belonging to this category/subcategory in which the contents to the preference of the user are included, the priority of the category/subcategory is temporarily increased so that the user can view the program more easily. At a predetermined timing, for example, after the program is ended, or after the user selects the viewing program, the priority temporarily increased is restored to the original priority of the category/subcategory.

Such an exceptional process for the priority will be described below using a specific example.

For example, it is supposed that the user who watches a soccer game of a specific favorite team does not usually view the variety program at all. At this time, in the priority information, the priority of the category “sports” or the subcategory “soccer” is high, and the priority of the category “variety” is low, as illustrated FIG. 3.

Herein, it is supposed that a soccer player whom the user likes very much appears in a variety talk program as the special edition. At this time, if there is no exceptional process for the priority, the possibility that the talk program in which the favorite soccer player appears is displayed in thumbnail is extremely low, because the priority of category “variety” is 10 and the priority of subcategory “talk” is 5, as shown in FIG. 3.

It is supposed that the <player name> of the soccer player whom the user is fond of is registered as the feature word corresponding to the category “sports”/subcategory “soccer” and the category “news”/subcategory “sports” in the program feature information.

In the exceptional process for the priority, the program feature extraction unit 116 analyzes each program of the EPG information, and extracts the feature word registered in the program feature information from each program. At this time, the program feature extraction unit 116 also extracts the feature word from the program of the category/subcategory different from the category/subcategory with which the feature word is associated, and notifies the result to the priority calculation unit 111. For example, the <player name> of the soccer player whom the user is fond of is extracted from information of the above variety talk program.

The priority calculation unit 111 determines that there is a program from which the feature word associated with the category/subcategory different from the belonging category/subcategory is extracted, if the subcategory with which the extracted feature word is associated does not belong to the category of the program from which the feature word is extracted, for example. The subcategories with which the feature word <player name> of the soccer player whom the user is fond of is associated are the subcategory “soccer” (belonging to the category “sports”) and the subcategory “sports” (belonging to the category “news”), and their subcategories do not belong to the category “variety” to which the program belongs. In such a case, it is determined that there is the program from which the feature word associated with the category/subcategory different from the belonging category/subcategory is extracted.

The priority calculation unit 111 specifies the priority of the category/subcategory with which the extracted feature word is associated, if there is the program from which the feature word associated with the category/subcategory different from the belonging category/subcategory is extracted. For example, if the priority of the category “sports”/subcategory “soccer” and the priority of the category “news”/subcategory “sports”, with which the <player name> of the soccer player is associated, are acquired from the priority information storage unit 103, the category “sports”=80/subcategory “soccer”=40 and the category “news”=40/subcategory “sports”=30 are obtained.

The category/subcategory to which the program from which the feature word associated with the different category/subcategory is extracted belongs is set to the highest priority of the category/subcategory with which the extracted feature word is associated. For example, since the highest value of the acquired priority of the category is the priority 80 of the category “sports”, the priority of category “variety” to which the variety talk program belongs is set to 80 in the priority information as illustrated in FIG. 3. Also, since the highest value of the acquired priority of the subcategory is the priority 40 of the subcategory “soccer”, the priority of subcategory “talk” to which the variety talk program belongs is set to 40 in the priority information as illustrated in FIG. 3. Herein, if the priority before changing the setting is higher, the temporary change of set priority is not made. For example, if the priority of category “variety” is 85 from the beginning, the temporary change of set priority is not made.

In the exceptional process for the priority to temporarily increase the priority of category/subcategory, for example, it is optional to decide the priority change range for changing the priority of category “variety” only in the variety talk program, or the set priority value to perform some arithmetic operation on the highest value of the acquired priority. Also, the upper limit value and the lower limit value of the priority to be changed may be provided, or the user may set the upper limit value and the lower limit value. For example, in the case where the upper limit value of temporarily changed priority is 70, the priority of category that is temporarily changed is set to 70, if the highest value of the priority of category to which the feature word belongs is 80.

The setting changed priority is restored to the original priority at a predetermined timing. For example, at a predetermined timing such as after the variety talk program is ended, after the user views the variety talk program, or after the user finishes selecting the program from the thumbnail display including the variety talk program, the priority of the category “variety”/subcategory “talk” to which the variety talk program belongs is restored to the original priority 10/5.

As regards updating the priority due to viewing the program, for example, no point is added to the priority of category “variety” and subcategory “talk”, but the point is added to the priority of category “sports” and subcategory “soccer” on which the setting changed priority is based in the example of the variety talk program.

In this manner, in the exceptional process for the priority to temporarily change the priority of category/subcategory, for example, the user who does not usually view variety programs at all can easily select viewing a variety program on which the favorite soccer player appears, whereby there is lower possibility that the user misses the program with possibility of viewing.

In the process for temporarily changing the priority of category/subcategory to which the program belongs, with the priority of category/subcategory to which the feature word extracted from the program information belongs, a determination may be made whether or not the priority of category/subcategory to which the extracted feature word belongs is greater than or equal to a predetermined threshold. At this time, if the priority of category/subcategory to which the extracted feature word belongs is not greater than or equal to the predetermined threshold, the priority is excluded from the candidates of priority for use in the process for temporarily changing the priority. The threshold of priority of category/subcategory to which the feature word belongs is set for each category of “sports” or “variety”, for example.

The threshold of priority of category/subcategory to which the feature word belongs may be changed by learning. For example, in the above example of the variety talk program, in the case where the priority of category “variety”/subcategory “talk” is increased and the variety talk program is displayed in thumbnail, the threshold set in the category “variety” is decreased, when the user selects the variety talk program, or the threshold set in the category “variety” is increased, when the user does not select the variety talk program.

If the user continues to select the variety talk program, the threshold set in the category “variety” is quickly decreased, so that it is easier to temporarily change the priority of category “variety”. Conversely, if the user continues not to select the variety talk program, the threshold set in the category “variety” is quickly increased, so that it is difficult to temporarily change the priority of category “variety”.

In this manner, by increasing or decreasing the threshold of priority of category/subcategory to which the feature word belongs by learning, it is possible to adapt the preference of the user such as “usually not watching news programs but if there is a news program including news regarding soccer, necessarily watching it” or “scarcely watching variety programs even if the soccer player appears on them”.

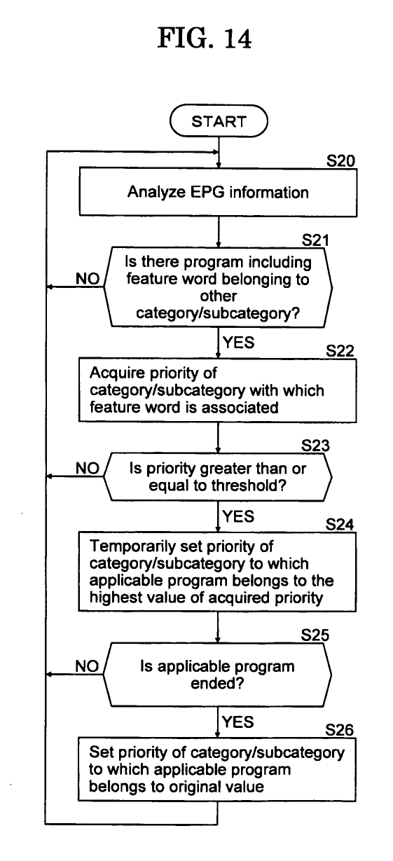

FIG. 14 is a priority temporary update processing flowchart according to this embodiment.

The program feature extraction unit 116 analyzes the EPG information (step S20). The priority calculation unit 111 checks whether or not there is the program including the feature word associated with the category/subcategory other than the belonging category/subcategory (step S21).

If there is the applicable program (YES at step S21), the priority of category/subcategory with which the feature word detected from the program is associated is acquired (step S22), and whether or not the acquired priority is greater than or equal to the threshold is checked (step S23).

If the priority is greater than or equal to the threshold (YES at step S23), the priority of category/subcategory to which the applicable program belongs is temporarily set to the highest priority among the acquired priorities greater than or equal to the threshold (step S24).

If the applicable program belonging to the category/subcategory in which the priority is temporarily changed is ended (YES at step S25), the priority of category/subcategory to which the applicable program belongs is set to the original value (step S26).

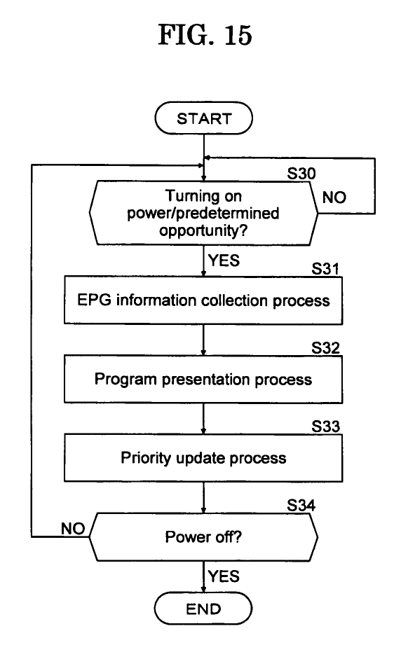

FIGS. 15 to 18 are flowcharts illustrating the processing flow according to this embodiment.

FIG. 15 is a flowchart illustrating an outline of processing flow of the television according to this embodiment. Herein, the priority of category unit is used as the priority for display, and if a plurality of programs belonging to the same category are broadcast, the displayed program is selected using the subcategory of the program.

When the power of the television 1 is turned on or at a predetermined opportunity (with the elapse of a predetermined time) (step S30), a collection process for the EPG information is performed by the EPG information collection unit 110 (step S31), and a presentation process for the program in thumbnail picture is performed by the display program control unit 112 and the program display processing unit 114 (step S32). Thereafter, an update process for the priority is performed by the priority calculation unit 111 (step S33). The processes from step S31 to step S34 are repeated by returning to the process of step S30 until the power off of the television 1 is determined (step S34).

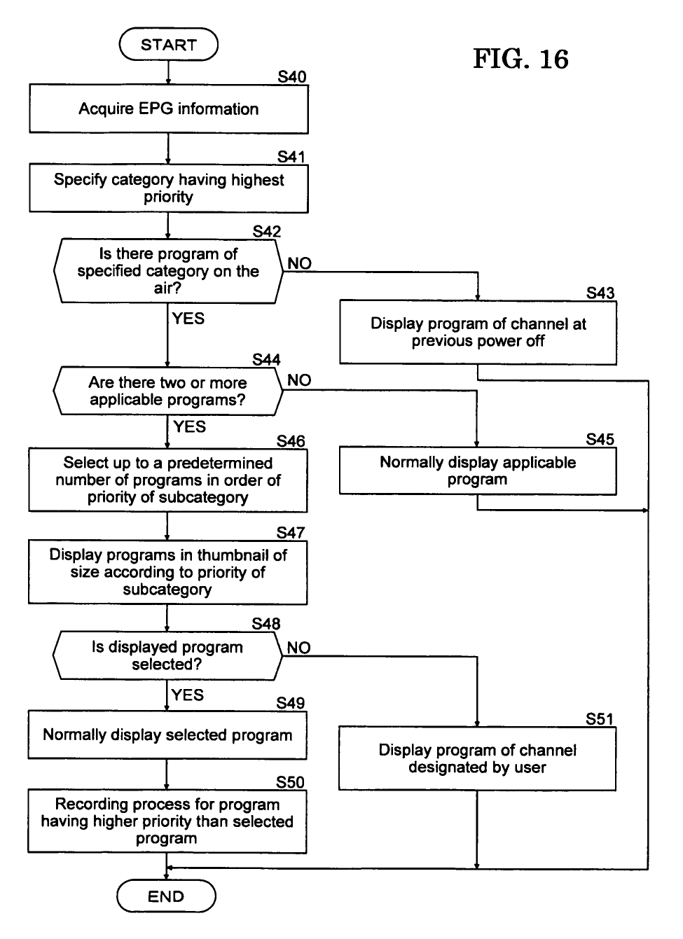

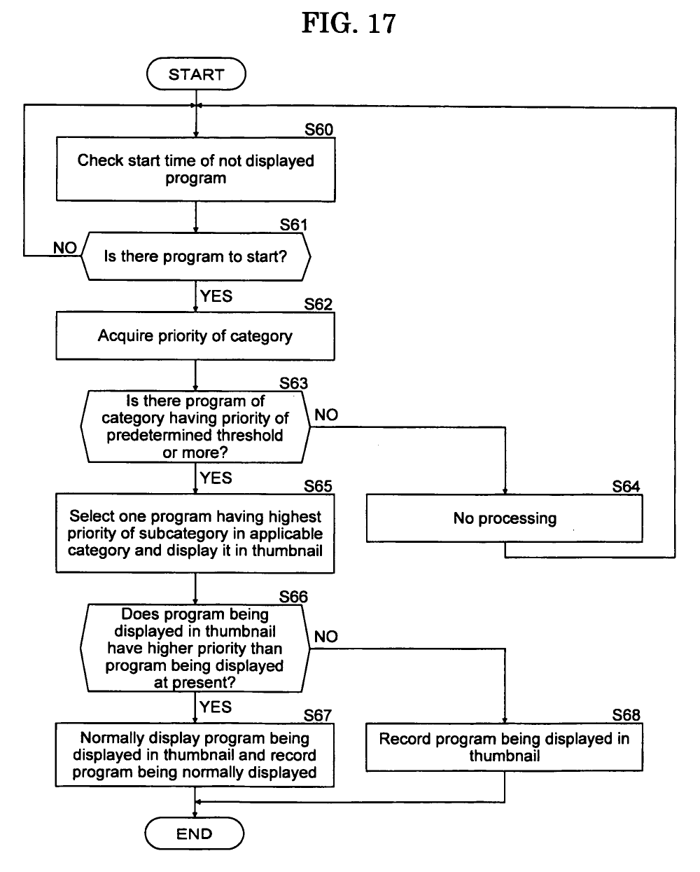

FIG. 16 is a flowchart illustrating a flow of the program presentation process when the power of the television is turned on according to this embodiment.

The display program control unit 112 of the television 1 acquires the EPG information of the program currently on the air from the EPG information storage unit 101 (step S40). Also, the category having the highest priority is specified from the priority information of category stored in the priority information storage unit 103 (step S41).

Whether or not there is the program on the air belonging to the specified category is checked with the acquired EPG information (step S42). If there is no applicable program on the air (NO at step S42), the program of the channel at the previous power off is displayed (step S43).

If there is the applicable program on the air (YES at step S42), it is checked whether or not there are two or more programs with the priority of belonging subcategory exceeding the predetermined threshold among the applicable programs (step S44). If there are no two or more applicable programs (NO at step S44), namely, if there is only one applicable program, the program display processing unit 114 displays the applicable program in normal picture (step S45).

If there are two or more applicable programs (YES at step S44), the display program control unit 112 selects the applicable programs with the priority of subcategory exceeding the predetermined threshold in order of priority up to a predetermined number of thumbnail pictures (step S46). The program display processing unit 114 displays the selected programs in thumbnail pictures of the size according to the priority of the subcategory (step S47).

The display program control unit 112 checks whether or not the program displayed in thumbnail picture is selected by the user (step S48). If the program displayed in thumbnail picture is selected (YES at step S48), the program display processing unit 114 displays the program selected by the user in normal picture by changing thumbnail picture to normal picture (step S49). Also, if there is any program with the priority of category or subcategory higher than the priority of category of the selected program, the display program control unit 112 specifies the program as the recording object to perform a recording process (step S50).

If the program displayed in thumbnail picture is not selected (NO at step S48), the program of the channel designated by the user is displayed (step S51).

FIG. 17 is a flowchart illustrating a flow of the program presentation process while the user is viewing the program according to this embodiment.

The display program control unit 112 of the television 1 checks the start time of the program not displayed by referring to the EPG information storage unit 101 (step S60), and if there is the program started at this time (YES at step S61), the priority of category of the applicable program is acquired from the priority information storage unit 103 (step S62). If the priority of category is not greater than or equal to the predetermined threshold (NO at step S63), no process is performed (step S64), and the operation returns to step S60.

If the priority of category is greater than or equal to the predetermined threshold (YES at step S63), the program display processing unit 114 selects one program with the highest priority of subcategory in the applicable category, and displays it in thumbnail picture (step S65).

Further, the display program control unit 112 acquires the priority of category for the program being displayed in normal picture at present and compares it with the priority of category for the program displayed in thumbnail picture (step S66). If the priority of category for the program displayed in thumbnail picture is higher than the priority of category for the program being displayed in normal picture at present (YES at step S66), the program displayed in thumbnail picture is changed and displayed in normal picture, and a recording process for the program being displayed in normal picture specified as the recording object is performed (step S67).

If the priority of category for the program displayed in thumbnail picture is not higher than the priority of category for the program being displayed in normal picture at present (NO at step S66), the program being displayed in thumbnail picture is recorded as the recording object (step S68).

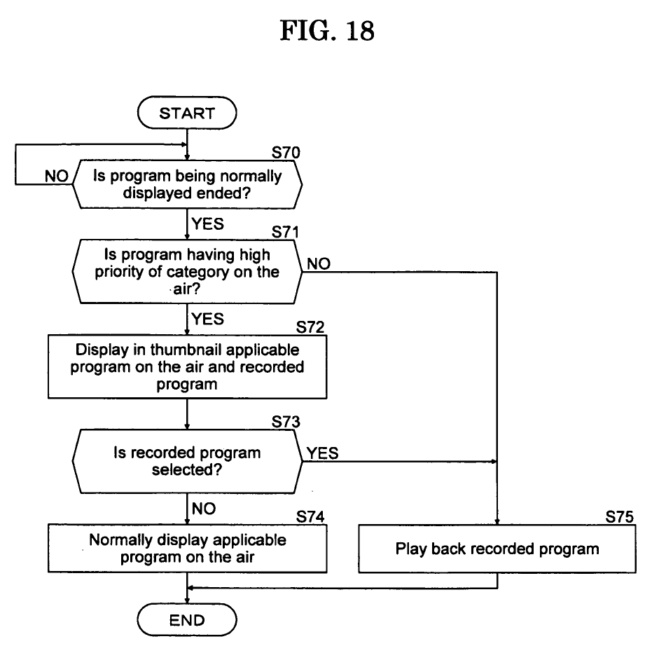

FIG. 18 is a flowchart illustrating a flow of the program presentation process when the program displayed in normal picture is ended according to this embodiment.

If the program being displayed in normal picture is ended (YES at step S70), the display program control unit 112 of the television 1 checks whether or not there is any program on the air in which the priority of belonging category is higher than the predetermined priority by referring to the EPG information storage unit 101 at this time (step S71). If there is no program on the air in which the priority of category is higher (NO at step S71), the program recording playback apparatus is notified to play back the recorded and stored program (step S75).

If there is the program on the air in which the priority of category is higher (YES at step S71), the program on the air in which the priority of category is higher and the recorded and stored program are displayed in thumbnail picture by referring to the recorded program information storage unit 104 (step S72).

If the recorded program is not selected from the thumbnail picture by the user (NO at step S73), the program currently on the air in which the priority of category is higher is displayed in normal picture by changing thumbnail picture to normal picture (step S74).

If the recorded program is selected from the thumbnail picture (YES at step S73), the program recording playback apparatus is notified to play back the recorded and stored program (step S75).

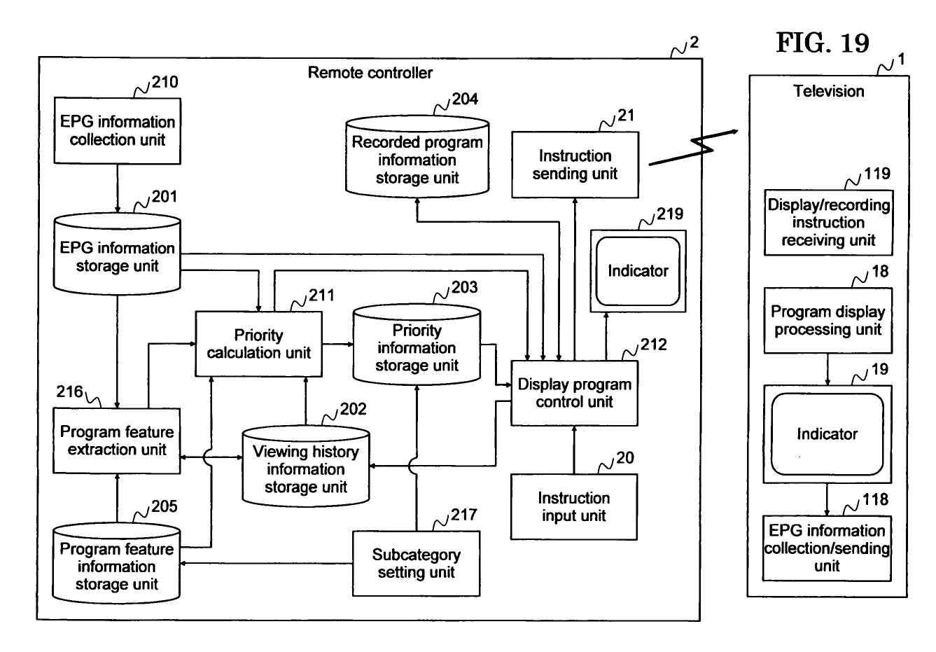

FIG. 19 is a diagram illustrating a configuration example where the remote controller is provided with a program presentation function and a priority update function according to this embodiment. In the example as illustrated in FIG. 19, the remote controller 2 as illustrated in FIG. 1 is provided with the program presentation function and the priority update function.

The remote controller 2 as illustrated in FIG. 19 includes, in addition to the instruction input unit 20 and the instruction sending unit 21, an EPG information storage unit 201, a viewing history information storage unit 202, a priority information storage unit 203, a recorded program information storage unit 204, a program feature information storage unit 205, an EPG information collection unit 210, a priority calculation unit 211, a display program control unit 212, a program feature extraction unit 216, and a subcategory setting unit 217. These processing units perform the same processes as the EPG information storage unit 101, the viewing history information storage unit 102, the priority information storage unit 103, the recorded program information storage unit 104, the program feature information storage unit 105, the EPG information collection unit 110, the priority calculation unit 111, the display program control unit 112, the program feature extraction unit 116, and the subcategory setting unit 117, respectively, for the television 1 as illustrated in FIG. 1. Also, the remote controller 2 may include an indicator 219.

The display program control unit 212 of the remote controller 2 displays a list of program names for the selected programs on the indicator 219, and sends the tuning data which indicates the broadcasting station of the program selected as the viewing object by the user or the information on the program of recording object through the instruction sending unit 21 to the television 1.

The instruction input unit 20 inputs a choice of the program name as the viewing object, or a switching instruction of displayed category from a list of viewable program names displayed on the indicator 219, instead of the thumbnail picture in the television 1.

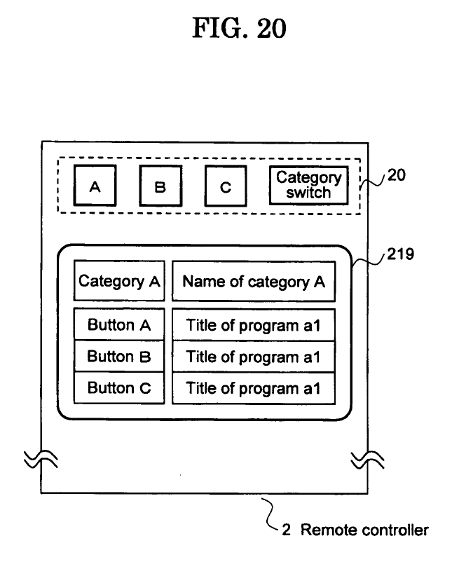

FIG. 20 is a view illustrating an example of the instruction input unit and the indicator in the remote controller according to this embodiment.

The buttons A, B and C included in the instruction input unit 20 are parts for inputting a selection of item, corresponding to the items A, B and C in the list of viewable programs displayed on the indicator 219. Also, the category switching button is a part for inputting a selection of category displayed on the indicator 219 by toggling.

In this embodiment, the television 1 includes a program display processing unit 18, an indicator 19, an EPG information collection/sending unit 118, and a display/recording instruction receiving unit 119, as illustrated in FIG. 19. The EPG information collection/sending unit 118 collects the EPG information, and sends it to the EPG information collection unit 210 of the remote controller 2. The display/recording instruction receiving unit 119 receives the instruction information originated from the instruction sending unit 21 of the remote controller 2.

Thereby, the user can select the program from the list of program names displayed on the indicator 219 of the remote controller 2, and make a selection operation for the program only with the remote controller 2 at hand.

Though this embodiment has been described above, it will be readily apparent that various variations may be made without departing from the spirit and scope of the invention.

For example, in this embodiment, the television 1 with the favorite program display function is taken as an example of the display device, but the display device may be a personal computer or a gadget which have a monitor and a tuner, such as a personal digital assistance, a mobile phone, or the like. Also, the display device may be a recording and playing back apparatus, such as an HDD recorder mounting a tuner, which can outputs the reproduced image to the external display device.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present inventions have been described in detail, it should be understood that the various changes, substitutions, and alterations could be made hereto without departing from the sprit and scope of the invention.

What is claimed is:

1. A display device having a function of displaying a broadcast program in accordance with preference of a user, the display device comprising:
a priority information storage unit for storing a priority for each category into which the program is classified;
a priority calculation unit for, when a program is viewed, calculating a priority of the category in order to increase the priority of the category to which the viewed broadcast program belongs;
a program feature information storage unit for storing correspondence information indicating a correspondence relation between the category and a feature word representing feature of the program classified into the category;
a program information collection unit for acquiring program information of the broadcast program at a predetermined opportunity;
a program feature extraction unit for extracting a feature word representing feature of the broadcast program from the acquired program information for each program;
a display program control unit for specifying the category, the priority of which is the highest, and selecting one or more programs belonging to the specified category among programs currently broadcasted; and
a program display processing unit for displaying the selected one or more programs;
wherein, when the program feature extraction unit extracts the feature word associated with a certain category from the program belonging to another different category than the associated category, the priority calculation unit temporarily changes the priority of the category to which the broadcast program, from which the feature word is extracted, belongs by using the priority of the category with which the feature word is associated.

2. The display device according to claim 1, wherein the category includes a first category into which the programs are classified according to a superordinate concept, and a second category into which the first category is further finely classified, and the program feature extraction unit specifies the second category with which the feature word is associated based on the feature word extracted from the program information and the correspondence information for each program, and
when the specified second category does not belong to the first category of the program from which the feature word is extracted, the priority calculation unit temporarily changes the priority of the second category or the priority of the first category from which the feature word is extracted by using the priority of the specified second category or the first category superior to the specified second category.

3. A display device having a function of displaying a broadcast program in accordance with preference of a user, the device comprising:
a priority information storage unit for storing a priority for each category into which the program is classified;
a priority calculation unit for, when a broadcast program is viewed, calculating a priority for the category in order to increase the priority of the category to which the viewed broadcast program belongs and decrease each priority of any other category than the category to which the viewed program belongs;
a program information collection unit for acquiring program information of the broadcast program at a predetermined opportunity;
a display program control unit for specifying the category, the priority of which is the highest, and selecting one or more programs belonging to the specified category among programs currently broadcasted; and
a program display processing unit for displaying the selected one or more programs.

4. The display device according to claim 3, further comprising a program feature information storage unit for storing correspondence information indicating a correspondence relation between the category and a feature word representing feature of the program that is classified into the category, and
a program feature extraction unit for extracting a feature word representing feature of the program from the acquired program information for each program,
wherein the category includes a first category into which the programs are classified according to a superordinate concept and a second category into which the first category is further finely classified, and
the program feature extraction unit specifies the second category to which the program belongs by using the feature word extracted from the program information and the correspondence information for each program, and
the priority calculation unit calculates the priority of the specified second category.

5. The display device according to claim 3, wherein the priority calculation unit decides the value of the priority so that the calculated priority of each category or subcategory falls in a range between of a predetermined upper limit and a predetermined lower limit.

6. The display device according to claim 3, further comprising a setting unit for making the setting for increasing or decreasing the priority performed by the priority calculation unit in accordance with a selection indicated by the user.

7. A remote operation device which sends an instruction signal to a display device having an instruction signal receiving unit for receiving the instruction signal and a program display processing unit for displaying a broadcast program instructed by the instruction signal, the remote operation device comprising:
a priority information storage unit for storing a priority for each category into which the program is classified;
a priority calculation unit for, when a broadcast program is viewed, calculating a priority of the category in order to increase the priority of the category to which the viewed program belongs;
a program feature information storage unit for storing correspondence information indicating a correspondence relation between the category and a feature word representing feature of the program that is classified into the category;
a program information collection unit for acquiring program information of the program at a predetermined opportunity;
a program feature extraction unit for extracting a feature word representing feature of the program from the acquired program information for each program;
a display program control unit for specifying the category, the priority of which is the highest, and selecting one or more programs belonging to the selected category among programs currently broadcasted; and
an instruction signal sending unit for displaying the program name of the selected program and sending to the display device an instruction signal whereby the program selected by the user is indicated as the viewing object;
wherein, when the program feature extraction unit extracts the feature word associated with a certain category from the program belonging to another different category from the associated category, the priority calculation unit temporarily changes the priority of the category to which the program, from which the feature word is extracted, belongs by using the priority of the category with which the feature word is associated.

8. A remote operation device which sends an instruction signal to a display device having an instruction signal receiving unit for receiving the instruction signal and a program display processing unit for displaying a broadcast program instructed by the instruction signal, the remote operation device comprising:
a priority information storage unit for storing a priority for each category into which the program is classified;
a priority calculation unit for, when a program is viewed, calculating the priority for the category in order to increase the priority of the category to which the viewed program belongs and decrease the priority of any other category than the category to which the viewed program belongs;
a program information collection unit for acquiring program information of the program at a predetermined opportunity;
a display program control unit for specifying the category, the priority of which is the highest, and selecting one or more programs belonging to the category among programs currently broadcasted; and
an instruction signal sending unit for displaying the program name of the selected program and sending to the display device an instruction signal whereby the program selected by the user is indicated as the viewing object.

9. A computer-readable medium storing a display program that is executed on a computer having a function for displaying a broadcast program in accordance with preference of a user, the display program causing the computer to function as a display device comprising:
a priority information storage unit for storing a priority for each category into which the program is classified;
a priority calculation unit for, when a broadcast program is viewed, calculating the priority of the category in order to increase the priority of the category to which the viewed broadcast program belongs;
a program feature information storage unit for storing correspondence information indicating a correspondence relation between the category and a feature word representing feature of the broadcast program classified into the category;
a program information collection unit for acquiring program information of the broadcast program at a predetermined opportunity;
a program feature extraction unit for extracting a feature word representing feature of the broadcast program from the acquired program information for each program;
a display program control unit for specifying the category, the priority of which is the highest, and selecting one or more programs belonging to the specified category among programs currently broadcasted; and
a program display processing unit for displaying the selected one or more programs;
wherein, when the program feature extraction unit extracts a feature word associated with a certain category from a program belonging to another different category from the associated category, the priority calculation unit temporarily changes the priority of the category to which the program, from which the feature word is extracted, belongs by using the priority of the category with which the feature word is associated.
